(19) United States
(12) Patent Application Publication
(10) Pub. No.: US 2024/0013324 A1
(43) Pub. Date: Jan. 11, 2024

(54) POWER SYSTEM

(71) Applicant: TOYOTA JIDOSHA KABUSHIKI KAISHA, Toyota-shi (JP)

(72) Inventors: Takashi MATSUMOTO, Toyota-shi (JP); Keiko HASEGAWA, Toyota-shi (JP); Masashi TAKAHASHI, Nagoya-shi (JP); Tohru NAKAMURA, Toyota-shi (JP); Ai MIYATA, Sakai-shi (JP)

(73) Assignee: TOYOTA JIDOSHA KABUSHIKI KAISHA, Toyota-shi (JP)

(21) Appl. No.: 18/144,068

(22) Filed: May 5, 2023

(30) Foreign Application Priority Data
Jul. 5, 2022 (JP) 2022-108412

(51) Int. Cl. G06Q 50/06; G06Q 10/02

(52) U.S. Cl. CPC G06Q 50/06; G06Q 10/02; G06Q 30/0235

(57) ABSTRACT

When an operation for reserving a rental car is performed on a communication terminal, reservation information is transmitted from the communication terminal to the management server. The management server extracts a reservation period included in the reservation information, issues an incentive based on the reservation period, and notifies the incentive. When the user applies an incentive to the communication device to confirm the reservation, the operation information is sent to the management server, and the management server confirms the reservation. When the reservation confirmation is notified, the communication terminal sets the reservation period as VPP participation period of the electrified vehicles, and transmits the participation information including the information of VPP participation period to HEMS controllers. HEMS controllers register the electrified vehicles as power resources in the period specified by VPP participation period.

### CROSS-REFERENCE TO RELATED APPLICATION

This application claims priority to Japanese Patent Application No. 2022-108412 filed on Jul. 5, 2022, incorporated herein by reference in its entirety.

### BACKGROUND

### 1. Technical Field

The present disclosure relates to a power system.

### 2. Description of Related Art

Japanese Unexamined Patent Application Publication No. 2011-139580 (JP 2011-139580 A) discloses an electrified vehicle capable of charging a battery mounted on a vehicle by receiving electric power supplied from a charging device installed in a complex housing such as an apartment house or a condominium.

### SUMMARY

In recent years, electrified vehicles capable of transmitting and receiving electric power (i.e., charging and discharging) to and from charging and discharging equipment have been widely used. It is desirable to use such electrified vehicles as power resources in the Virtual Power Plant (VPP) to stabilize a power grid. Therefore, it is desired to construct a measure for promoting the participation of electrified vehicles in the VPP.

The present disclosure has been made in order to solve the above problems, and an object of the present disclosure is to promote use of an electrified vehicle as a power resource and to promote stabilization of a power grid.
(1) A power system according to the present disclosure includes: a communication terminal carried by a user of a vehicle; a first server that uses the vehicle connected to charging and discharging equipment that is able to transmit and receive electric power to and from a power grid as a power resource; and a second server of a business operator that operates or lends a mobile body.
   The first server uses the vehicle as the power resource during a period in which a reservation for the mobile body is made with the second server from the communication terminal.
   The second server issues an incentive to the user when the reservation of the mobile body is made with the second server from the communication terminal.

According to the configuration above, the first server uses the vehicle as the power resource during the period in which the reservation for the mobile body is made with the second server from the communication terminal. It is assumed that the user does not use the vehicle during the period in which the reservation of the mobile body is made. The issuance of the incentive facilitates the use of the vehicle as the power resource during the period. Therefore, stabilization of the power grid can be promoted.
(2) In an embodiment, the second server determines the incentive in accordance with the period.

According to the above configuration, the incentive is issued in accordance with the period in which the reservation is made, that is, the period in which the vehicle is used as the power resource. The configuration is adopted in which a larger incentive is issued as the period becomes longer, whereby the use of the vehicle as the power resource can be promoted.
(3) In an embodiment, the second server determines the incentive in accordance with charging and discharging electric energy from the vehicle to the power grid when the vehicle is used as the power resource.

According to the above configuration, the incentive is issued in accordance with the charging and discharging electric energy from the vehicle to the power grid. The configuration is adopted in which a larger incentive is issued as the charging and discharging electric energy becomes larger, whereby the use of the vehicle as the power resource can be promoted.
(4) In an embodiment, the communication terminal notifies the first server of a period in which the reservation of the mobile body is made with the second server as a period in which the vehicle is usable as the power resource.

According to the above configuration, the first server can recognize the period in which the vehicle can be used as the power resource.
(5) In an embodiment, the communication terminal includes a display screen. The first server transmits a notification prompting a connection of the vehicle to the charging and discharging equipment to the communication terminal when a time prior to a time when the mobile body is used as the power resource by a predetermined time arrives. The communication terminal causes the display screen to display the notification.

When the vehicle is forgotten to be connected to the charging and discharging equipment, the vehicle cannot be used as the power resource. According to the above configuration, since the notification prompting the connection of the vehicle to the charging and discharging equipment is displayed on the communication terminal, it is possible to suppress forgetting to connect the vehicle to the charging and discharging equipment.

According to the present disclosure, it is possible to promote the use of the electrified vehicle as the power resource and to promote the stabilization of the power grid.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a power system according to an embodiment;

FIG. 2 is a sequence diagram showing a flow of a series of processes executed by HEMS controller, the communication terminal, and the management server; and

FIG. 3 is a sequence diagram illustrating a flow of a series of processes executed by HEMS controller, the communication terminal, and the management server in Modification 1.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### Overall Configuration of the Power System

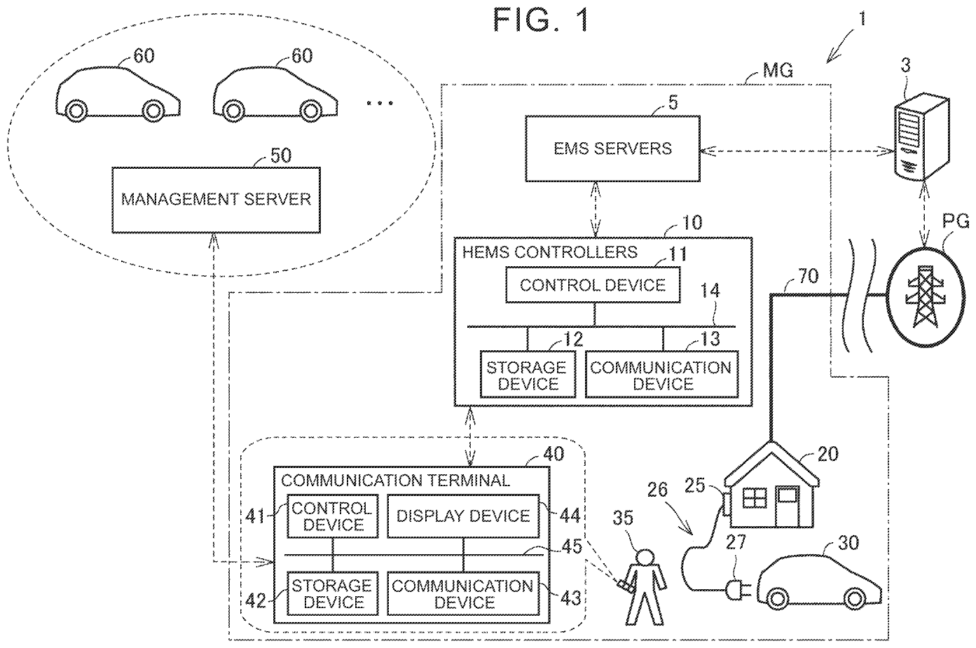

FIG. 1 is a diagram illustrating a schematic configuration of a power system 1 according to the present embodiment. The power system 1 includes a power grid PG, a power transmission and distribution provider servers 3, and a microgrid MG.

The microgrid MG according to the present embodiment is a small-scale power grid constructed in a predetermined area. The microgrid MG includes Energy Management System (EMS) servers 5, power resource groups including residences 20 and electrified vehicles 30, and power lines 70.

The supply and demand of the electric power in the microgrid MG is managed by EMS servers 5. The power line 70 for networking power resources in the microgrid MG may be a self-contained power line. The microgrid MG is configured to be parallel and disconnectable to the power grid PG.

The power transmission and distribution provider servers 3 are computers that manage the supply and demand of the power grid PG. The power grid PG is a power grid constructed by a power plant and a transmission and distribution facility (not shown). In the present embodiment, the electric power company also serves as a power generation company and a power transmission and distribution company. Electric power companies maintain and manage power grid PG (commercial electric power system). The electric power companies correspond to administrators of the power grid PG. The power transmission and distribution provider server 3 belongs to a power company.

EMS server 5 is configured to be able to communicate with each of the power transmission and distribution provider server 3 and the power resource group. The communication protocol may be an OpenADR. The power resource group includes a plurality of power resources electrically connectable to the power line 70. Each of the plurality of power resources serves as a distributed power source in the microgrid MG. EMS servers 5 are configured to manage a plurality of power resources included in the power resource group. EMS server 5 may perform a demand response (DR) on the power resource group when the power transmission and distribution provider server 3 requests to adjust the supply and demand of the power grid PG. In addition, EMS servers 5 may perform a demand response on the power resource group in accordance with the power-market agreement. In addition, EMS servers 5 may perform demand response on the power resource group in order to adjust supply and demand of the microgrid MG. EMS servers 5 control the power resources connected to the microgrid MG to cause the power resources to function as a virtual power plant (VPP). More specifically, EMS servers 5 cause the power resource group to function like a single power plant by remotely controlling and integrally controlling the power resource group by an energy management technique using the Internet of Things (IoT).

When EMS server 5 acquires the request information for requesting the supply-and-demand adjustment of the power grid PG from the power transmission and distribution provider server 3, it creates a plan for responding to the request. The request information includes at least a type, an amount of electric power, a start time, and an end time. The types include a “first request” requesting to suppress the power demand of the power grid PG or reverse power flow, or a “second request” requesting to increase the power demand of the power grid PG. The amount of electric power when the type is the “first request” indicates, for example, the amount of electric power supplied by the power grid PG, and the amount of electric power when the type is the “second request” indicates, for example, the amount of electric power received by the power grid PG. The start time is a request time for starting power supply or power reception, and the end time is a request time for ending power supply or power reception.

EMS servers 5 create a demand response (DR) based on the supply-demand request (request data). The demand response includes a “lowering” DR requesting a reduction or reverse flow of power demand in the microgrid MG, and a “raising DR” requesting an increase in power demand in the microgrid MG. Specifically, when EMS server 5 receives the request information indicating the type of the first request from the power transmission and distribution provider server 3, it creates a lowering DR so that the required amount of supplied power can be supplied from the microgrid MG to the power grid PG, and transmits the lowering DR to the power resource group. When EMS server 5 receives the request information indicating the type of the second request from the power transmission and distribution provider server 3, it creates the raising DR so that the microgrid MG can receive the requested received power quantity from the power grid PG, and transmits the raising DR to the power resource group. When the power resource group subjected to the lowering DR and the raising DR responds appropriately, the supply and demand of the power grid PG are stabilized.

The power resource group includes a house 20 and an electrified vehicle 30. In the present embodiment, an example is shown in which the power resource group includes one house 20 and one electrified vehicle 30, but the power resource group may include a plurality of houses and a plurality of electrified vehicles. Further, the power resources may include various power resources, such as an Energy Storage System (ESS) and a generator, although none of them are shown. These power resources are electrically connected to the power line 70.

The house 20 includes various household electric appliances (household appliances) and Home Energy Management System (HEMS controllers 10 (not shown). The household appliance is electrically connected to an in-house power line. The house 20 includes a smart meter (not shown), and the in-house power line is electrically connected to the power line 70 via the smart meter. The smart meter is an electronic watt-hour meter having a communication function, measures the amount of electric power exchanged between the power line 70 and the house 20 during a predetermined measurement period (for example, 30 minutes), and transmits the measured amount of electric power to EMS servers or HEMS controllers 10 at predetermined intervals (for example, every 60 minutes).

The house 20 includes charging and discharging equipment 25. The charging and discharging equipment 25 is provided with a charging and discharging cable 26. Note that the charge-discharge cable 26 may be of a type in which a plug is inserted into an outlet of the house 20. A connector 27 is provided at a distal end of the charge-discharge cable 26. In the present embodiment, the owner or the resident of the house 20 owns the electrified vehicle 30. When the connector 27 is connected to a connection port (not shown) of the electrified vehicle 30, the charging and discharging equipment 25 (the house 20) and the electrified vehicle 30 are electrically connected to each other. The electrified vehicle 30 functions as a power resource by being electrically connected to the charging and discharging equipment 25. In the following description, an owner or a resident of the house 20 and the owner of the electrified vehicle 30 is referred to as a “user 35”.

HEMS controllers 10 are configured to be able to communicate with the household appliances and the charging and discharging equipment 25. HEMS controllers 10 control the household appliances and the charging and discharging equipment 25.

The electrified vehicle 30 is, for example, a battery electric vehicle configured to be capable of external charging and discharging for exchanging electric power of an in-vehicle battery with a power source outside the electrified vehicle. Note that the electrified vehicle 30 is not limited to a battery electric vehicle as long as it can be externally charged and discharged. The electrified vehicles 30 may be, for example, plug-in hybrid electric vehicle or plug-in fuel cell electric vehicle.

In order to stabilize the power grid PG, it is desired to promote VPP utilization. In order to promote VPP utilization, it is desirable to utilize electrified vehicles for VPP. Therefore, it is desired to construct a measure for promoting the participation of electrified vehicles in VPP.

In the present embodiment, when the user 35 who owns the electrified vehicle 30 makes a reservation for another mobile body, the electrified vehicle 30 participates in VPP during the reservation. In a case where a reservation of another mobile body object is made, it is assumed that the electrified vehicle 30 is not used in the reservation period. Therefore, the electrified vehicle 30 can be effectively used by causing the electrified vehicle to participate in VPP during that time. An incentive is given to the user 35 who has permitted the use of the electrified vehicles 30 for VPP during the reserved period. Incentives are provided to the user 35 to facilitate the use of the electrified vehicles 30 for VPP. Hereinafter, a specific description will be given. In the present embodiment, a rental car is assumed as a mobile body reserved by a user. For example, a rental car may be used from the viewpoint of a battery electric vehicle cruising range, the viewpoint of the number of passengers, and/or the viewpoint of a vehicle cabin space, etc., when traveling. In such cases, it is assumed that the electrified vehicle 30 is not used during use of the rental car, and therefore it is desirable to use the electrified vehicle 30 for VPP.

The management server 50 is a server belonging to a business operator who operates a rental car business. The business operator owns a plurality of vehicles 60, and rents out a plurality of vehicles 60 as rental cars.

The management server 50 manages a plurality of vehicles 60. The management server 50 accepts a rental car reservation via predetermined application software (hereinafter, also referred to as “predetermined application”) provided to the marketplace. The predetermined application is application software for coordinating the reservation of the rental car to the management server 50 and the participation in VPP.

The user 35 owns the communication terminal 40. The communication terminal 40 is, for example, a smartphone. The communication terminal 40 is not limited to a smartphone, and may be a tablet terminal, a personal computer, or the like.

A predetermined application is installed in the communication terminal 40. For example, the user 35 can access the marketplace using the communication terminal 40 and install a predetermined application in the communication terminal 40. After installing the predetermined application on the communication terminal 40, the user 35 performs initial setting of the predetermined application, for example, and registers user information and information (for example, Vehicle Identification Number) for specifying the electrified vehicles 30.

The communication terminal 40 includes a control device 41, a storage device 42, a communication device 43, and a display device 44. The control device 41, the storage device 42, the communication device 43, and the display device 44 are connected to the bus 45.

The storage device 42 is configured to store various types of information. The storage device 42 stores a program to be executed by the control device 41 and information (for example, a map, a mathematical expression, and various parameters) used in the program. Further, the storage device 42 stores a predetermined application.

The communication device 43 includes various communication I/F. The communication device 43 is configured to communicate with HEMS controllers 10 and the management servers 50.

The control device 41 controls each unit of the communication terminal 40 in accordance with an input to the communication terminal 40. The input is, for example, a signal by an input operation of the user 35 to the communication terminal 40, a signal from HEMS controller 10, or a signal from the management server 50.

The display device 44 includes, for example, a touch panel display using a liquid crystal panel. The display device 44 receives, for example, a touch operation by a user.

The user 35 operates the communication terminal 40 at an arbitrary timing to execute a predetermined application (launch the predetermined application), and makes a rental car reservation to the management server 50. When the predetermined application is executed, for example, an input form is displayed on the display device 44 (the display screen of the communication terminal 40). The input form includes, for example, a selection field of a vehicle type and an input field of a rental period. The information input in the input form is acquired by the management server 50, and the reservation of the rental car is confirmed by the management server 50 based on the information.

When the reservation of the rental car is confirmed, the control device 41 of the communication terminal 40 transmits, via the communication device 43, information indicating a period (hereinafter, also referred to as a “reservation period”) during which the user 35 reserves the rental car to HEMS controllers 10. At this time, the control device 41 of the communication terminal 40 also transmits the vehicle-identification-information to HEMS controllers 10 via the communication device 43.

HEMS controllers 10 include a control device 11, a storage device 12, and a communication device 13. The control device 11, the storage device 12, and the communication device 13 are connected to a bus 14.

The storage device 12 is configured to be capable of storing various types of information. The storage device 12 stores information (for example, a map, a mathematical expression, and various parameters) used in the program in addition to the program executed by the control device 11. Further, the storage device 12 stores a period during which the electrified vehicles 30 can participate in VPP (hereinafter, also referred to as a “VPP participation period”).

The communication device 13 includes various communication I/F. The communication device 13 is configured to be able to communicate with EMS servers 5 and the communication terminals 40.

The control device 11 controls each unit of HEMS controllers 10. When the reservation period is acquired from the communication terminal 40 via the communication device 13, the control device 11 causes the storage device 12 to store the acquired reservation period as a VPP participation period of the electrified vehicles 30. The control device 11 identifies the electrified vehicle 30 based on the vehicle identification information.

The control device 11 controls each household electric appliance and the charging and discharging equipment 25. When the demand response (DR) requesting the supply-and-demand adjustment of the microgrid MG is acquired from EMS server 5, a plan for responding to the demand response is created. When receiving the lowering DR, the control device 11 controls the household electric appliances, the charging and discharging equipment 25, and the electrified vehicles 30 so that the required supplied electric power can be supplied from the house 20 to the microgrid MG (power line 70). When receiving the raising DR, the control device 11 controls the household electric appliances, the charging and discharging equipment 25, and the electrified vehicles 30 so that the house 20 can receive the required received electric power from the microgrid MG.

When the reservation of the electrified vehicle 30 is confirmed, the management server 50 gives an incentive corresponding to the reservation period to the user 35. The incentive may be, for example, a discount on the rental car fee. The incentive source may be borne by the car rental business operator, for example, for the purpose of using the car rental service of the car rental business operator, or may be borne by the electric power company or the administration entity of EMS servers 5 for the purpose of having the car rental business operator participate in VPP. The incentive is provided to facilitate the user 35 to join the electrified vehicles 30 to VPP during a rental car usage period (e.g., a travel period).

Further, the control device 11 of HEMS controller 10 transmits a notification prompting the communication terminal 40 to connect the connector 27 of the charge-discharge cable 26 to the connection port of the electrified vehicle 30 when a time (hereinafter, also referred to as a “notification time”) that is a predetermined time prior to the arrival of the start of VPP participation time of the electrified vehicle 30 arrives. Upon receiving the notification, the control device 41 of the communication terminal 40 causes the display device 44 to display the notification. Accordingly, the user 35 can recognize that the connector 27 should be connected to the connection port of the electrified vehicle 30. Therefore, it is possible to suppress the electrified vehicle 30 from being unable to participate in VPP because the user 35 forgets to connect the connector 27 to the connecting port of the electrified vehicle 30 and moves in the rental car.

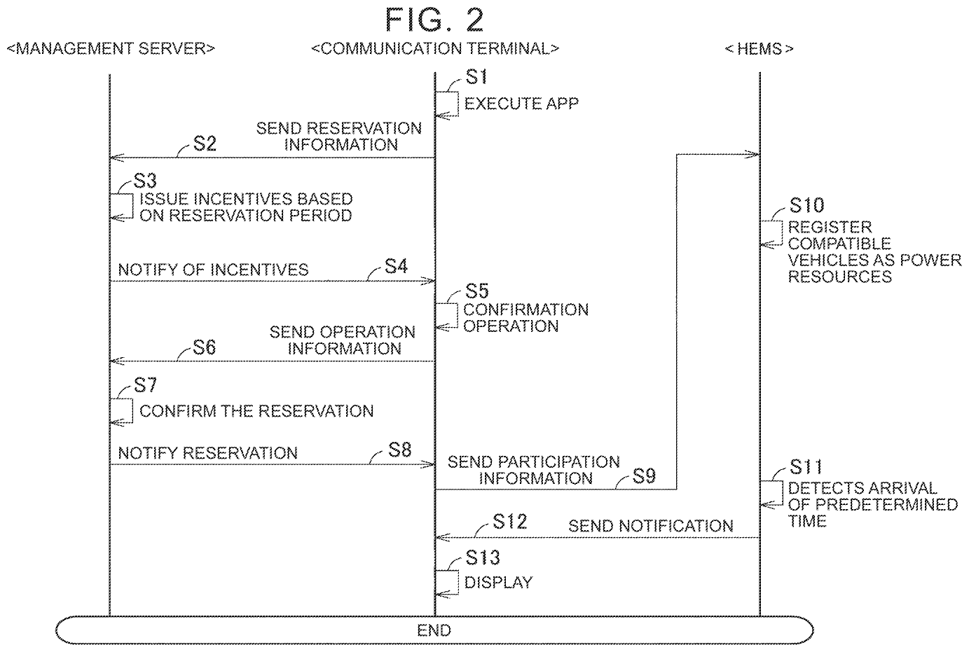

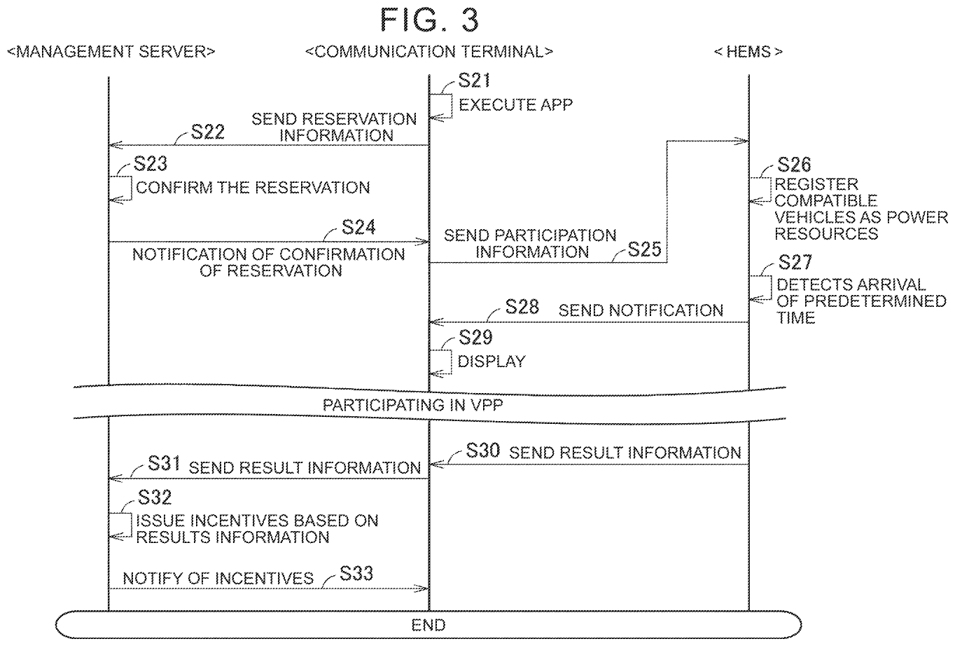

Further details will be described with reference to FIG. 2. FIG. 2 is a sequence diagram illustrating a flow of a series of processes executed by HEMS controller the communication terminal 40, and the management server 50. Although the steps illustrated in FIG. 2 and FIG. 3 (hereinafter, steps are abbreviated as “S”) are realized by software processes performed by HEMS controller 10, the communication terminal 40, and the management server 50, some or all of them may be realized by hardware (electric circuitry) created in HEMS controller 10, the communication terminal 40, and the management server 50.

In S1, the user 35 operates the communication terminal 40 to execute (launch) a predetermined application. In response to the operation, the communication terminal 40 executes a predetermined application and causes the display device 44 to display a reservation form for reserving a rental car. The user 35 operates the communication terminal 40 to input an item (for example, a selection field of a vehicle type and an input field of a rental period) indicated in the reservation form.

In S2, the communication terminal 40 transmits the information entered in the reservation form to the management server 50 as the reservation information.

In S3, the management server 50 receives the reservation information from the communication terminal 40. The management server 50 extracts a reservation period included in the reservation information before confirming the reservation, and issues an incentive based on the reservation period. In a storage device (not shown) of the management server 50, for example, a map indicating a relationship between the reservation period and the incentive is stored in advance. The management server 50 issues a larger incentive as the reservation period is longer. This is because the longer the reserved period, the longer the period during which the electrified vehicles 30 participate in VPP. The incentive may be, for example, a discount on the rental car fee and/or an extended coupon on the rental car.

In S4, the management servers 50 notify the communication terminals 40 of the incentives issued by S3. As a result, an incentive is issued to the user 35.

In S5, the communication terminal 40 causes the display device 44 to display the received notification. The user 35 performs an operation for viewing the content of the notification. In response to the operation, the communication terminal 40 causes the display device 44 to display the contents of the incentive. When the user 35 applies the incentive to the present rental car reservation, the user performs an operation for applying the incentive, and then performs an operation for confirming the reservation. When the user does not apply the incentive to the present rental car reservation, the user performs an operation for confirming the reservation. The communication terminal 40 receives a series of operations by the user 35.

In S6, the communication terminal 40 transmits operation information indicating a series of operations of the user 35 to the management server 50.

In S7, the management server 50 receives the operation information from the communication terminal 40. The management server 50 confirms the reservation of the rental car based on the operation information. Specifically, when information indicating that an incentive is applied is included in the operation information, the management server 50 corrects the reservation content to the reservation content to which the incentive is applied, and confirms the reservation with the corrected reservation content. When information indicating that an incentive is to be applied is not included in the operation information, the management server 50 confirms the reservation while keeping the original reservation contents.

In S8, the management server 50 transmits information indicating the determined reservation content to the communication terminal 40, and notifies the determined reservation.

In S9, when receiving the notification of the reservation confirmation from the management server 50, the communication terminal 40 sets the reservation period as VPP participation period of the electrified vehicle 30, and transmits the participation information including the information of VPP participation period to HEMS controller 10. The participation information includes information for specifying the electrified vehicle 30 (for example, vehicle identification information) in addition to the information on VPP participation period.

In S10, when the participation information is acquired, HEMS controllers register the electrified vehicle 30 specified based on the vehicle identification information as the power resource in the period specified by VPP participation period.

In S11, HEMS controllers 10 detect the arrival of a time (notification time) that is a predetermined time prior to the arrival of the start of VPP participation period. HEMS controller 10 generates a notification prompting the connection of the connector 27 of the charge-discharge cable 26 to the connection port of the electrified vehicle 30.

In S12, HEMS controllers 10 transmit the notifications created by S11 to the communication terminals 40.

In S13, the communication terminal 40 causes the display device 44 to display a notification. The display content may be for causing the user 35 to recognize the necessity of connecting the connector 27 to the connection port, for example, “Remember to connect the connector 27 to the connection port of the electrified vehicle 30”. The display contents can be changed as appropriate. When the notification is displayed on the display screen (the display device 44) of the communication terminal 40, the user 35 forgets to connect the connector 27 to the connection port of the electrified vehicle 30 and moves in the rental car, thereby suppressing the electrified vehicle 30 from participating in VPP.

As described above, in the present embodiment, when the rental car is reserved for the management server 50 by using the predetermined application installed in the communication terminal 40, the reservation period is transmitted to HEMS controller 10 as VPP participation period of the electrified vehicle 30. Then, HEMS controllers 10 use the electrified vehicles 30 as electric power resources during VPP participation period. Since it is assumed that the electrified vehicle 30 is not used in the reserved period (the rental car use period), the electrified vehicle 30 can be effectively used by causing the electrified vehicle to participate in VPP during that period. An incentive is given to the user 35 who has permitted the use of the electrified vehicles 30 for VPP during the reserved period. Incentives are given to the user, thereby promoting the use of the electrified vehicles 30 for VPP. Therefore, VPP utilization is promoted, and the power grid PG can be stabilized.

### First Modification

In the embodiment, an example in which an incentive is issued based on a rental car reservation period has been described. In the embodiment, an incentive is issued regardless of the result of the electrified vehicle 30 participating in VPP. However, there may be a case in which the electrified vehicle 30 is not actually available for VPP due to, for example, forgetting to connect the connector 27 to the connection port of the electrified vehicle 30. Therefore, in Modification 1, an example in which incentives are issued in accordance with a result of participating in VPP of the electrified vehicles 30 will be described.

FIG. 3 is a sequence diagram illustrating a flow of a series of processes executed by HEMS controller 10, the communication terminal 40, and the management server 50 in Modification 1.

In S21, the user 35 operates the communication terminal 40 to execute (launch) a predetermined application. In response to the operation, the communication terminal 40 executes a predetermined application and causes the display device 44 to display a reservation form for reserving a rental car. The user 35 operates the communication terminal 40 to input an item (for example, a selection field of a vehicle type and an input field of a rental period) indicated in the reservation form.

In S22, the communication terminal 40 transmits the information entered in the reservation form to the management server 50 as the reservation information.

In S23, the management server 50 confirms the reservation of the rental car based on the reservation information.

In S24, the management server 50 transmits information indicating the determined reservation content to the communication terminal 40, and notifies the determined reservation.

In S25, when receiving the notification of the reservation confirmation from the management server 50, the communication terminal 40 sets the reservation period as VPP participation period of the electrified vehicle 30, and transmits the participation information including the information of VPP participation period to HEMS controller 10.

In S26, when the participation information is acquired, HEMS controllers 10 register the electrified vehicles 30 specified based on the vehicle identification information included in the participation information as the power resource in the period specified by the information of VPP participation period.

In S27, HEMS controllers 10 detect the arrival of a time (notification time) that is a predetermined time prior to the arrival of the start of VPP participation period. HEMS controller 10 generates a notification prompting the connection of the connector 27 of the charge-discharge cable 26 to the connection port of the electrified vehicle 30.

In S28, HEMS controllers 10 transmit the notifications created by S27 to the communication terminals 40.

In S29, the communication terminal 40 causes the display device 44 to display a notification. The displayed content is as described in S13 in FIG. 2.

After S29, when VPP participation period arrives, HEMS controllers 10 respond to the demand response from EMS servers 5 by using the electrified vehicles 30 as power resources. HEMS controllers 10 monitor a period in which the electrified vehicles 30 are used as electric power resources (a period in which the electrified vehicles participate in VPP), charge-discharge power, and the like.

In S30, HEMS controllers 10 transmit, to the communication terminals 40, the results indicating the results of participating in VPP by the electrified vehicles 30. The result information includes, for example, a period in which the electrified vehicle 30 is used as a power resource (hereinafter, also referred to as an “actual participation period”), charging and discharging electric energy of the electrified vehicle 30 with respect to the power line and the like.

In S31, the communication terminal 40 transmits the data received from HEMS controllers 10 to the management servers 50.

In S32, the management server 50 issues an incentive based on the result-information received from the communication terminal 40. In the storage device (not shown) of the management server 50, for example, a map indicating the relationship between the preliminary participation period or the charging and discharging electric energy and the incentive is stored in advance. For example, the management server 50 issues a larger incentive as the actual participation period included in the result information is longer. Alternatively, the management server 50 issues a larger incentive as the charging and discharging electric energy included in the result information increases. Further, a map indicating the relationship between the actual participation period, the charging and discharging electric energy, and the incentive may be stored in advance in the storage device of the management server 50, and the incentive may be issued based on the combination of the actual participation period and the charging and discharging electric energy. The incentive according to Modification 1 is, for example, a coupon or the like that can be used in the next rental car reservation. The incentive is different from the incentive according to the embodiment in that the incentive can be used in the next rental car reservation.

In S33, the management servers 50 notify the communication terminals 40 of the incentives issued by S32. As a result, an incentive is issued to the user 35.

As described above, even in a configuration in which incentives are issued in accordance with a result of participating in VPP of the electrified vehicle 30, it is possible to promote the use of the electrified vehicle 30 in VPP while the electrified vehicle 30 is not used. Therefore, as in the embodiment, VPP utilization is promoted, and the power grid PG can be stabilized.

### Second Modification

In the embodiment and the modification 1, an example in which the mobile body reserved by the user 35 is a rental car has been described. In the first embodiment and the first modification, the period during which the user 35 reserves the rental car is defined as VPP participation period of the electrified vehicle 30 owned by the user 35, and the period during which the electrified vehicle 30 can be used as a power resource is associated with the reservation period of the rental car. However, it is not limited to a rental car reservation period that is associated with a period during which the electrified vehicle 30 can be used as a power resource. The time period during which the electrified vehicle 30 can be used as a power resource can be associated with a reservation time period of another mobile body that can be assumed by the user 35 not to use the electrified vehicle 30.

Examples of the mobile body include, for example, a high-speed railway, an aircraft, a ship, a car sharing, a two-wheeled vehicle, and the like. The communication terminal 40 that has executed the predetermined application is configured to be able to communicate with the management server that manages the above-described mobile body. The management server that manages the mobile body has the same function as the management server 50 described in the embodiment or the modification 1.

Further, a predetermined application can be configured to make reservations for a plurality of mobile bodies such as high-speed railways, aircraft, ships, car sharing, rental cars, motorcycles, and the like. That is, in the communication terminal 40 that has executed the predetermined application, the user 35 can select a reservation destination from among a plurality of mobile bodies such as a high-speed railway, an aircraft, a ship, car sharing, a rental car, and a two-wheeled vehicle. Each of the management servers that manage the mobile body has the same function as the management server 50 described in the embodiment or the modification 1. The management server 50 illustrated in FIGS. 2 and 3 can be replaced with a management server that manages the selected mobile body.

Also in the configuration according to Modification 2, it is possible to promote utilization of the electrified vehicles 30 for VPP, to promote VPP utilization, and to stabilize the power grid PG.

### Modification 3

In the embodiment and the modifications 1 and 2, an example in which the electrified vehicles 30 owned by the user 35 participate in VPP has been described. However, the electrified vehicles that participate in VPP may not be owned by the user 35. For example, if the user 35 is borrowing the rental car for a long period of time (e.g., months, etc.), the rental car may participate in VPP. For example, by activating a predetermined application and registering the rental car, the rental car can be handled in the same manner as the electrified vehicle 30.

The embodiments disclosed herein should be considered to be exemplary and not restrictive in all respects. The scope of the present disclosure is shown by the scope of claims rather than the description of the above embodiments, and is intended to include all modifications within the meaning and the scope equivalent to the scope of claims.

What is claimed is:

1. A power system comprising:
a communication terminal carried by a user of a vehicle;
a first server that uses the vehicle connected to charging and discharging equipment that is able to transmit and receive electric power to and from a power grid as a power resource; and
a second server of a business operator that operates or lends a mobile body, wherein:
the first server uses the vehicle as the power resource during a period in which a reservation for the mobile body is made with the second server from the communication terminal; and
the second server issues an incentive to the user when the reservation of the mobile body is made with the second server from the communication terminal.

2. The power system according to claim 1, wherein the second server determines the incentive in accordance with the period.

3. The power system according to claim 1, wherein the second server determines the incentive in accordance with charging and discharging electric energy from the vehicle to the power grid when the vehicle is used as the power resource.

4. The power system according to claim 1, wherein the communication terminal notifies the first server of a period in which the reservation of the mobile body is made with the second server as a period in which the vehicle is usable as the power resource.

5. The power system according to claim 4, wherein:
the communication terminal includes a display screen;
the first server transmits a notification prompting a connection of the vehicle to the charging and discharging equipment to the communication terminal when a time prior to a time when the mobile body is used as the power resource by a predetermined time arrives; and
the communication terminal causes the display screen to display the notification.
